(19) United States
(12) Patent Application Publication
(10) Pub. No.: US 2019/0179739 A1
(43) Pub. Date: Jun. 13, 2019

(54) FACILITATING GENERATION OF STANDARDIZED TESTS FOR TOUCHSCREEN GESTURE EVALUATION BASED ON COMPUTER GENERATED MODEL DATA

(71) Applicant: GE AVIATION SYSTEMS LIMITED, Cheltenham (GB)

(72) Inventors: Mark Andrew Smith, Cheltenham (GB); George Robert William Henderson, Cheltenham (GB); Luke Patrick Bolton, Cheltenham (GB)

(21) Appl. No.: 16/201,270

(22) Filed: Nov. 27, 2018

(30) Foreign Application Priority Data
Dec. 11, 2017 (GB) 1720610.3

(51) Int. Cl. G06F 11/36; G06F 3/0488

(52) U.S. Cl. CPC G06F 11/3692; G06F 3/04883; G06F 11/3688

(57) ABSTRACT

Facilitating generation of standardized tests for touchscreen gesture evaluation based on computer generated model data is provided. A system comprises a memory (110) that stores executable components and a processor (112), operatively coupled to the memory, that executes the executable components. The executable components can comprise a mapping component (102) that correlates a set of operating instructions to a set of touchscreen gestures and a sensor component (104) that receives sensor data from a plurality of sensors. The sensor data can be related to implementation of the set of touchscreen gestures. The set of touchscreen gestures can be implemented in an environment that experiences vibration or turbulence. Further, the executable components can comprise an analysis component (106) that analyzes the sensor data and assesses respective performance data and usability data of the set of touchscreen gestures relative to respective operating instructions.

### TECHNICAL FIELD

The subject disclosure relates generally to touchscreen gesture evaluation and to facilitating generation of standardized tests for touchscreen gesture evaluation based on computer generated model data.

### BACKGROUND

Human machine interfaces can be designed to allow an entity to interact with a computing device through one or more gestures. For example, the one or more gestures can be detected by the computing device and, based on respective functions associated with the one or more gestures, an action can be implemented by the computing device. Such gestures are useful in situations where the computing device and the user remain stationary with little, if any, movement. However, in situations where there are constant, unpredictable movements, such as unstable situations associated with air travel, the gestures cannot be easily performed and/or cannot be accurately detected by the computing device. Accordingly, gestures cannot effectively be utilized with computing devices in an unstable environment.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

One or more embodiments provide a system that can comprise a memory that stores executable components and a processor, operatively coupled to the memory, that executes the executable components. The executable components can comprise a mapping component that correlates a set of operating instructions to a set of touchscreen gestures. The operating instructions can comprise at least one defined task performed with respect to a touchscreen of a computing device. The executable components can also comprise a sensor component that receives sensor data from a plurality of sensors. The sensor data can be related to implementation of the set of touchscreen gestures. The set of touchscreen gestures can be implemented in an environment that experiences vibration or turbulence according to some implementations. Further, the executable components can comprise an analysis component that analyzes the sensor data and assesses performance score/data and/or usability score/data of the set of touchscreen gestures relative to respective operating instructions of the set of operating instructions. The performance score/data and/or usability score/data can be a function of a suitability of the set of touchscreen gestures within the defined environment (e.g., an environment that experiences vibration or turbulence).

Also, in one or more embodiments, a computer-implemented method is provided. The computer-implemented method can comprise mapping, by a system comprising a processor, a set of operating instructions to a set of touchscreen gestures. The operating instructions can comprise a defined set of related tasks performed with respect to a touchscreen of a computing device. The computer-implemented method can also comprise obtaining, by the system, sensor data that is related to implementation of the set of touchscreen gestures. Further, the computer-implemented method can comprise assessing, by the system, performance score/data and/or usability score/data of the set of touchscreen gestures relative to respective operating instructions of the set of operating instructions based on an analysis of the sensor data. In some implementations, the set of touchscreen gestures can be implemented in a controlled non-stationary environment.

In addition, according to one or more embodiments, provided is a computer readable storage device comprising executable instructions that, in response to execution, cause a system comprising a processor to perform operations. The operations can comprise matching a set of operating instructions to a set of touchscreen gestures and obtaining sensor data that is related to implementation of the set of touchscreen gestures within a non-stable environment. The operations can also comprise training a model based on the set of operating instructions, the set of touchscreen gestures, and the sensor data. Further, the operations can also comprise analyzing performance score/data and/or usability score/data of the set of touchscreen gestures relative to respective operating instructions of the set of operating instructions based on an analysis of the sensor data and the model.

To the accomplishment of the foregoing and related ends, the disclosed subject matter comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, non-limiting, system for facilitating control gesture testing in accordance with one or more embodiments described herein;

FIG. 2 illustrates another example, non-limiting, system for function gesture evaluation in accordance with one or more embodiments described herein;

FIG. 3 illustrates an example, non-limiting, implementation of a standardized test for a pan/move function test in accordance with one or more embodiments described herein;

FIG. 4 illustrates an example, non-limiting, first embodiment of the pan/move function test of FIG. 3 in accordance with one or more embodiments described herein;

FIG. 5 illustrates an example, non-limiting, second embodiment of the pan/move function test of FIG. 3 in accordance with one or more embodiments described herein;

FIG. 6 illustrates an example, non-limiting, third embodiment of the pan/move function test of FIG. 3 in accordance with one or more embodiments described herein;

FIG. 7 illustrates an example, non-limiting, fourth embodiment of the pan/move function test of FIG. 3 in accordance with one or more embodiments described herein;

FIG. 8 illustrates an example, non-limiting, first embodiment of an increase/decrease function test in accordance with one or more embodiments described herein;

FIG. 9 illustrates an example, non-limiting, second embodiment of the increase/decrease function test of FIG. 8 in accordance with one or more embodiments described herein;

FIG. 10 illustrates an example, non-limiting, third embodiment of the increase/decrease function test of FIG. 8 in accordance with one or more embodiments described herein;

FIG. 11 illustrates an example, non-limiting, fourth embodiment of the increase/decrease function test of FIG. 8 in accordance with one or more embodiments described herein;

FIG. 12 illustrates an example, non-limiting, first embodiment of an increase/decrease function test in accordance with one or more embodiments described herein;

FIG. 13 illustrates an example, non-limiting, second embodiment of the increase/decrease function test of FIG. 12 in accordance with one or more embodiments described herein;

FIG. 14 illustrates an example, non-limiting, third embodiment of the increase/decrease function test of FIG. 12 in accordance with one or more embodiments described herein;

FIG. 15 illustrates an example, non-limiting, fourth embodiment of the increase/decrease function test of FIG. 12 in accordance with one or more embodiments described herein;

FIG. 16 illustrates a representation of an example, non-limiting, “go to” function task that can be implemented in accordance with one or more embodiments described herein;

FIG. 17 illustrates another example, non-limiting, system for function gesture evaluation in accordance with one or more embodiments described herein;

FIG. 18 illustrates an example, non-limiting, computer-implemented method for facilitating touchscreen evaluation tasks intended to evaluate gesture usability for touchscreen functions in accordance with one or more embodiments described herein;

FIG. 19 illustrates an example, non-limiting, computer-implemented method for generating standardized tests for touchscreen gesture evaluation in an unstable environment in accordance with one or more embodiments described herein;

FIG. 20 illustrates an example, non-limiting, computer-implemented method for evaluating risk benefit analysis associated with touchscreen gesture evaluation in an unstable environment in accordance with one or more embodiments described herein;

FIG. 21 illustrates an example, non-limiting, computing environment in which one or more embodiments described herein can be facilitated; and

FIG. 22 illustrates an example, non-limiting, networking environment in which one or more embodiments described herein can be facilitated.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

Various aspects provided herein relate to determining an effectiveness of gesture based control in a volatile environment prior to implementation of the gestures in the volatile environment. Specifically, the various aspects relate to a series of computer based evaluation tasks designed to evaluate gesture usability for touchscreen functions (e.g., a touchscreen action, a touchscreen operation). A “gesture” is a touchscreen interaction that is utilized to express an intent (e.g., selection of an item on the touchscreen, facilitating movement on the touchscreen, causing a defined action to be performed based on an interaction with the touchscreen). As discussed herein, the various aspects can evaluate the usability of gestures for a defined function and a defined environment. The usability can be determined by the time taken for the tasks to be completed, the accuracy in which the tasks were completed, or a combination of both accuracy and time to completion.

Human machine interfaces (HMIs) designed for flight decks or other implementations that experience vibration and/or turbulence should be developed with tactile usability in mind. As an example, for aviation, this can involve considering scenarios such as turbulence, vibration, and positioning of interfaces within the flight deck or another defined environment. There is growing interest in using touch screens in the flight deck and with touch screens becoming ubiquitous in the consumer market there are now a large number of common gestures that can be used to express a single intent to the system. However, these common gestures are not suitable in environments that are unstable. Accordingly, provided herein are embodiments that can determine the usability of various gestures and suitability of the gestures in non-stationary environments. For example, unstable or non-stationary environments can include, but are not limited to, environments encountered during land navigation, marine navigation, aeronautic navigation, and/or space navigation. Although the various aspects are discussed with respect to an unstable environment, the various aspects can also be used in a stable environment.

The various aspects can provide objective ratings (rather than subjective ratings) of touchscreen gestures. The objective ratings can be collected and utilized in conjunction with various subject usability scales to determine with more certainty the usability of a system with dedicated gestures for a single user intent.

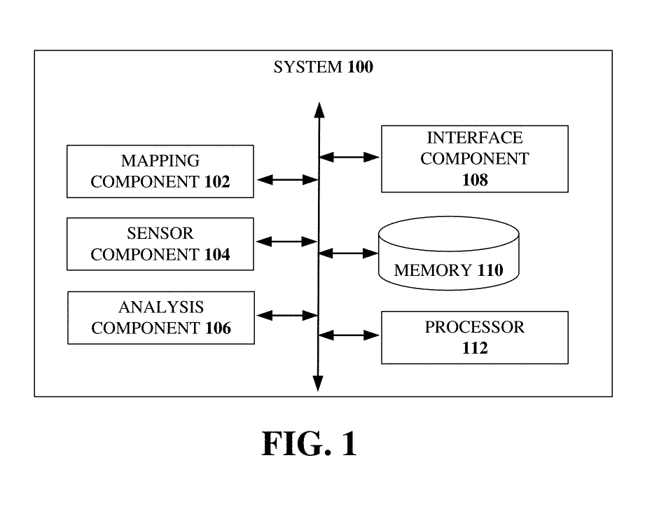

FIG. 1 illustrates an example, non-limiting, system 100 for facilitating control gesture testing in accordance with one or more embodiments described herein. The system 100 can be configured to perform touchscreen evaluation tasks intended to evaluate gesture usability for touchscreen functions. The evaluation of the gesture usability can be for touchscreen functions that are performed in a non-stationary or non-stable environment, according to some implementations. For example, the evaluation can be performed for environments that experience vibration and/or turbulence. Such environments can include, but are not limited to nautical environments, nautical applications, aeronautical environments, and aeronautical applications.

The system 100 can comprise a mapping component 102, a sensor component 104, an analysis component 106, an interface component 108, at least one memory 110, and at least one processor 112. The mapping component 102 can correlate a set of operating instructions to a set of touchscreen gestures. The operating instructions can comprise at least one defined task performed with respect to a touchscreen of a computing device. According to some implementations, the operating instructions can comprise a set of related tasks to be performed with respect to the touchscreen of the computing device. For example, the set of operating instructions can include instructions for an entity to interact, through an associated computing device, with a touch-screen of the interface component 108.

According to some implementations, the interface component 108 can be a component of the system 100. However, according to some implementations, the interface component 108 can be separate from the system 100, but in communication with the system 100. For example, the interface component 108 can be associated with a device co-located with the system (e.g., within a flight simulator) and/or a device located remote from the system (e.g., a mobile phone, a tablet computer, a laptop computer, and other computing devices).

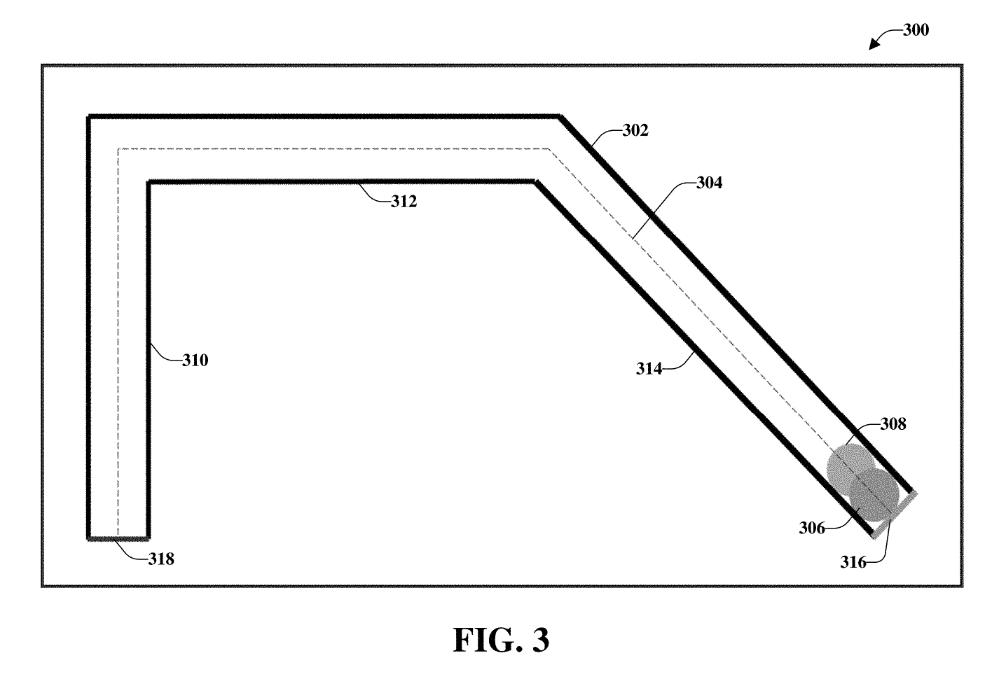

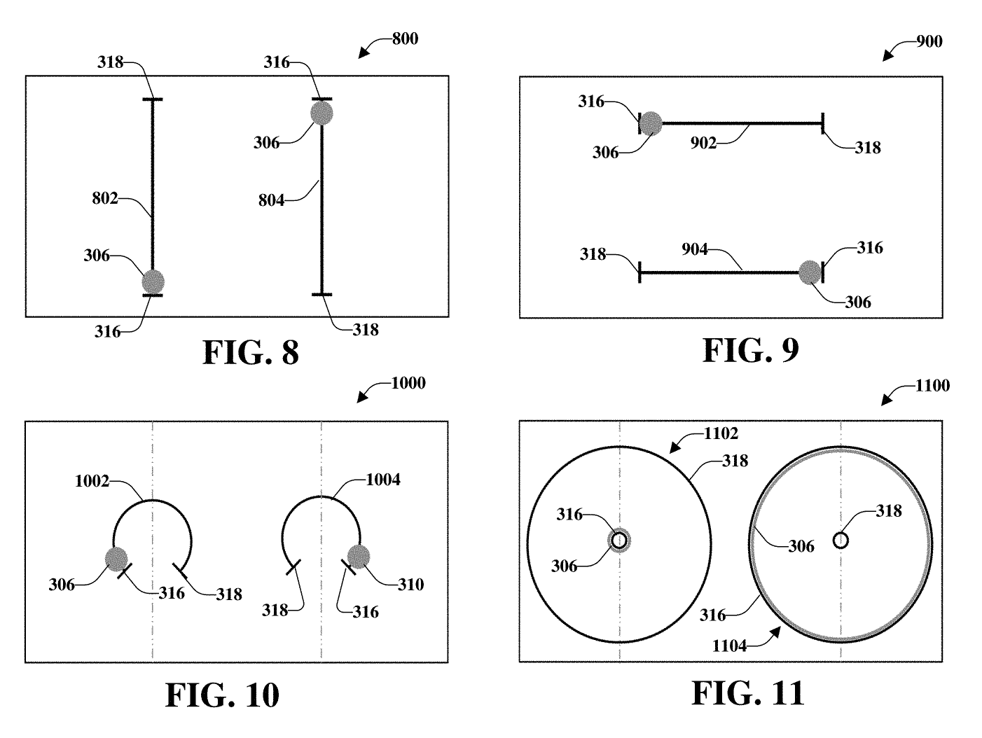

The instructions can include detailed instructions, which can be visual instructions and/or audible instructions. According to some implementations, the instructions can advise the entity to perform various functions through interaction with an associated computing device. The various functions can include “pan/move,” “increase/decrease,” “go next/go previous” (e.g., “go to”), and/or “clear/remove/delete.” The pan/move function can include dragging an item (e.g., a finger, a pen device) across the screen and/or dragging two items (e.g., two fingers) across the screen. The dragging movement of the items(s) can be in accordance with a defined path. Further details related to an example, non-limiting pan/move function will be provided below with respect to FIGS. 3-7. The increase/decrease function can include dragging an object up, down, right, and/or left on the screen. Another increase/decrease function can include clockwise and/or counterclockwise rotation. Yet another increase/decrease function can include pinching and/or spreading a defined element within the screen. Further details related to an example, non-limiting increase/decrease function will be provided below with respect to FIGS. 8-15. The “go to” function can include swiping (or “flicking”) an object left, right, up, and/or down on the screen.

The sensor component 104 can receive sensor data from one or more sensors 114. The one or more sensors 114 can be included, at least partially within the interface component 108. The one or more sensors can include touch sensors that are located within the interface component 108 and associated with the display. According to an implementation, the sensor data can be related to implementation of the set of touchscreen gestures. For example, the set of touchscreen gestures can be implemented in an environment that experiences vibration or turbulence, is a non-stationary environment, and/or is a non-stable environment. In some implementations, the touchscreen gestures can be tested in an environment that experiences little, if any, vibration or turbulence.

The analysis component 106 can analyze the sensor data. For example, the analysis component 106 can evaluate whether a gesture conformed to a defined gesture path or expected movement. Further, the analysis component 106 can assess performance score/data and/or usability score/data of the set of touchscreen gestures relative to respective operating instructions of the set of operating instructions. The performance score/data and/or usability score/data can be a function of a suitability of the touchscreen gestures within the testing environment (e.g., a stable environment, an environment that experiences vibration or turbulence, and so on). For example, if a touchscreen gesture is not suitable for the environment, a high percentage of errors can be detected. In an implementation, the performance score data can relate to a number of times a gesture deviated from the defined gesture path, locations within the defined gesture path where one or more deviations occurred, inability to perform the gesture, and/or inability to complete a gesture (e.g., from a defined start position to a defined end position).

The at least one memory 110 can be operatively coupled to the at least one processor 112. The at least one memory 110 can store computer executable components and/or computer executable instructions. The at least one processor 112 can facilitate execution of the computer executable components and/or the computer executable instructions stored in the at least one memory 110. The term “coupled” or variants thereof can include various communications including, but not limited to, direct communications, indirect communications, wired communications, and/or wireless communications.

Further, the at least one memory 110 can store protocols associated with facilitating standardized tests for touchscreen gesture evaluation in an environment, which can be a stable environment, or an unstable environment, as discussed herein. In addition, the at least one memory 110 can facilitate action to control communication between the system 100, other systems, and/or other devices, such that the system 100 can employ stored protocols and/or algorithms to achieve improved touchscreen gesture evaluation as described herein.

It is noted that although the one or more computer executable components and/or computer executable instructions can be illustrated and described herein as components and/or instructions separate from the at least one memory 110 (e.g., operatively connected to at least one memory 110), the various aspects are not limited to this implementation. Instead, in accordance with various implementations, the one or more computer executable components and/or the one or more computer executable instructions can be stored in (or integrated within) the at least one memory 110. Further, while various components and/or instructions have been illustrated as separate components and/or as separate instructions, in some implementations, multiple components and/or multiple instructions can be implemented as a single component or as a single instruction. Further, a single component and/or a single instruction can be implemented as multiple components and/or as multiple instructions without departing from the example embodiments.

It should be appreciated that data store components (e.g., memories) described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

The at least one processor 112 can facilitate respective analysis of information related to touchscreen gesture evaluation. The at least one processor 112 can be a processor dedicated to determining suitability of one or more gestures based on data received and/or based on a generated model, a processor that controls one or more components of the system 100, and/or a processor that both analyzes and generates models based on data received and controls one or more components of the system 100.

According to some implementations, the various systems can include respective interface components (e.g., the interface component 108) or display units that can facilitate the input and/or output of information to the one or more display units. For example, a graphical user interface can be output on one or more display units and/or mobile devices as discussed herein, which can be facilitated by the interface component. A mobile device can also be called, and can contain some or all of the functionality of a system, subscriber unit, subscriber station, mobile station, mobile, mobile device, device, wireless terminal, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a feature phone, a wireless local loop (WLL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects can also be implemented with wired devices, or with both wired and wireless devices.

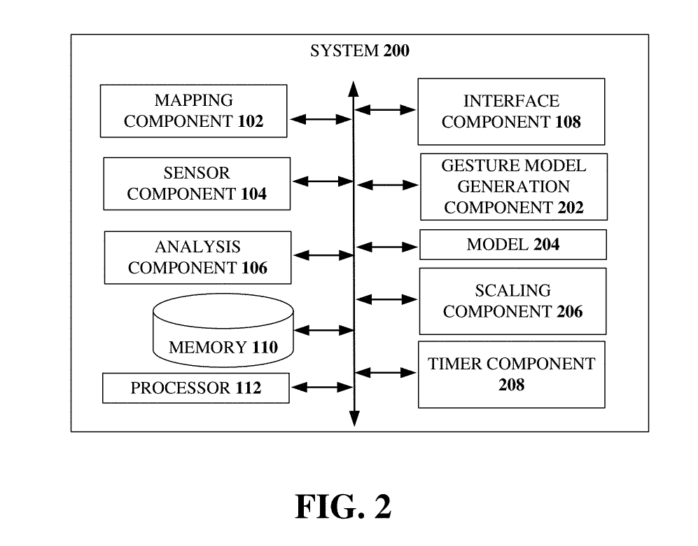

FIG. 2 illustrates another example, non-limiting, system 200 for function gesture evaluation in accordance with one or more embodiments described herein. Repetitive description of like elements employed in other embodiments described herein is omitted for sake of brevity.

The system 200 can comprise one or more of the components and/or functionality of the system 100 and vice versa. The system 200 can comprise a gesture model generation component 202 that can generate a gesture model 204 based on operating data received from a multitude of computing devices, which can be located within the system 200 and/or located remote from the system 200. In some implementations, the gesture model 204 can be trained and normalized as a function of data from more than one device. The data can be operating data and/or test data that can be collected by the sensor component 104. According to some implementations, the gesture model 204 can learn touchscreen gestures relative to the respective operating instructions of the set of operating instructions. For example, the set of operating instructions can comprise one or more gestures and one or more tasks (e.g., instructions) that should be carried out with respect to the one or more gestures.

In accordance with some implementations, the gesture model generation component 202 can train the gesture model 204 through cloud-based sharing across a multitude of models. The multitude of models can be based on the operating data received from the multitude of computing devices. For example, multiple gesture based testing can be performed at different locations. Data and analysis can be gathered and analyzed at the different locations. Further, respective models can be trained at the different locations. The models created at the different locations can be aggregated through the cloud-based sharing across the one or more models. By sharing models and related information from different locations (e.g., testing centers) robust gesture training and analysis can be facilitated, as discussed herein.

The system 200 can also comprise a scaling component 206 that performs touchscreen gesture analysis as a function of touchscreen dimensions of the computing device. For example, various devices can be utilized to interact with the system 200. The various devices can be mobile devices, which can comprise different footprints and, therefore, display screens that can be different sizes. In an example, a test can be performed on a large screen and the gesture model 204 can be trained on the large screen. However, a similar test is to be performed on a smaller screen and, therefore, the scaling component 206 can utilize the gesture model 204 to rescale the test as a function of the available real estate (e.g. display size). In such a manner, the tests can remain the same regardless of the device on which the tests are being performed. Therefore, the one or more tests can be standardized across a variety of devices.

According to some implementations, the scaling component 206 can perform the touchscreen gesture analysis as a function of respective sizes of one or more objects (e.g., fingers, thumbs, or portions thereof) detected by the touchscreen of the computing device. For example, if fingers are utilized to interact with the touchscreen, the fingers could be too large for the screen area and, therefore, errors could be encountered based on the size of the fingers. In another example, the fingers could be smaller than average and, therefore, the amount of time spent completing the one or more tasks could take longer due to the extra distance that has to be traversed on the screen due to the small finger size.

It is noted that although various dimensions, screen ratios, and/or other numerical definitions could be described herein, these details are provided merely to explain the disclosed aspects. In various implementations, other dimensions, screen ratios, and/or other numerical definitions can be utilized with the disclosed aspects.

According to some implementations, a timer component 208 can measure various amounts of time spent successfully performing a task and/or portions of the task. For example, the timer component 208 can begin to track an amount of time when a test is selected (e.g., when a start test selector is activated). In another example, the timer component 208 can begin to track the time upon receipt of a first gesture (e.g., as determined by one or more sensors and/or the sensor component 104).

Additionally, or alternatively, the gesture analysis can include a series of tests or tasks that are output. Upon or after the test is started, a time to successfully complete a first gesture can be tracked by the timer component 208. Further, an amount of time that elapses between completion of the first task and a start of a second task can be tracked by the timer component 208. The start of the second task can be determined based on receipt of a next gesture by the sensor component 104 after completion of the first task. According to another example, the start of the second task can be determined based on interaction with one or more objects associated with the second task. An amount of time for completion of the second task, another amount of time between the second task and a third task, and so on, can be tracked by the timer component 208.

According to some implementations, one or more errors can be measured by the timer component 208 as a function of the respective time spent deviating from a target path associated with the at least one defined path. For example, a task can indicate that a gesture should be performed and a target path should be followed while performing the gesture. However, according to some implementations, since the gesture could be performed in an environment that is unstable (e.g., experiences vibration, turbulence, or other disruptions), a pointing item (e.g., a finger) could deviate from the target path (e.g., lose contact with the touchscreen) due to the movement. In some implementations, a defined amount of deviation could be expected due to the instability of the environment in which the gesture is being performed. However, if the amount of deviation is over the defined amount, it can indicate an error and, therefore, the gesture could be unsuitable for the environment being tested. For example, the environment could have too much vibration or movement, rendering the gesture unsuitable.

FIG. 3 illustrates an example, non-limiting, implementation of a standardized test for a pan/move function test 300 in accordance with one or more embodiments described herein. Repetitive description of like elements employed in other embodiments described herein is omitted for sake of brevity. It is noted that although particular standardized tests are illustrated and described herein, the disclosed aspects are not limited to these implementations. Instead, the example, non-limiting standardized tests are illustrated and describe to facilitate describing the one or more aspects provided herein. Thus, other standardized tests can be utilized with the disclosed aspects.

The pan/move function test 300 can be utilized to simulate dragging and/or moving an object on a touchscreen of the device. For example, a test channel 302 that has a defined width can be rendered. According to some implementations, the test channel 302 can have a similar width along its length. However, in some implementations, different areas of the test channel 302 can have different widths.

A defined path 304 within the outline can be utilized by the analysis component 106 to determine whether one or more errors has occurred during the gesture. For example, the one or more errors can be measured as a function of time spent deviating from the defined path 304. Also rendered can be a test object 306 which is the object that the entity can interact with (e.g., though multi-touch). For example, the test object 306 can be selected and moved during the test. According to some implementations, a ghost object 308 can also be rendered. The ghost object 308 is an object whose path the entity can attempt to mimic with the test object. For example, the ghost object 308 can be output along the path at a position to which the test object 306 should be moved. According to some implementations, the test object 306 and the ghost object 308 can be about the same size and/or shape. However, according to other implementations, the test object 306 and the ghost object 308 can be different sizes and/or shapes. Further, in some implementations, the test object 306 and the ghost object 308 can be rendered in different colors or other manners of distinguishing between the objects.

The defined path 304 can be designed to allow the sensor component 104 and/or one or more sensors to evaluate movement along the vertical axis (e.g., a Y direction 310), movement on the horizontal axis (e.g., the X direction 312), and movement on both the horizontal axis and the vertical axis (e.g., an XY combined direction 314). In the example illustrated, the pan/move function test 300 can begin at a first position (e.g., a start position 316) and can end at a second position (e.g., a stop position 318). During the testing procedure, the test object 306 can be located at various positions along the defined path 304 or at a position located within the test channel 302 but not on the defined path 304 (e.g., the test channel 302 and/or test object 306 can be sized such that movement inside the test channel 302 can deviate from the defined path 304) or outside the test channel 302.

According to some implementations, if an object (e.g., a finger) is removed from the test object, the test object will remain where it is located and will not reset to the starting position. Further, there is no feedback when the boundaries of the channel have been broken. The test object can freely move anywhere on the screen and is not constrained by the channel. Further, a timing can start when the test object is touched and can end when the finish line (e.g., stop position) is touched.

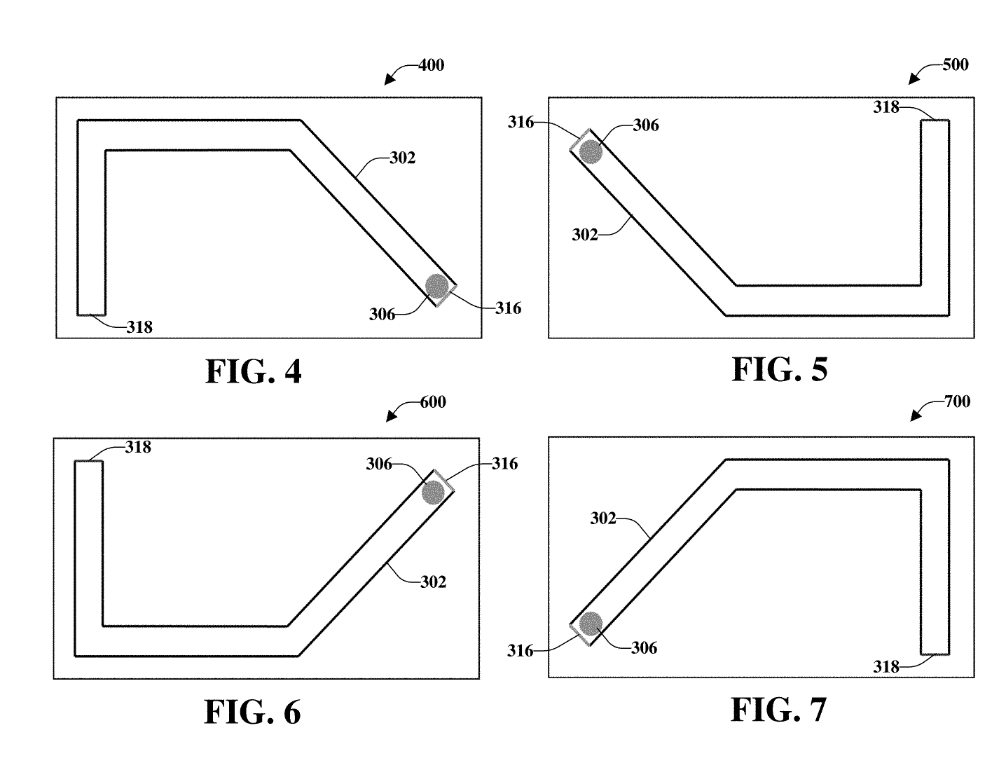

FIGS. 4-7 illustrate example, non-limiting implementations of the pan/move function test 300 of FIG. 3 in accordance with one or more embodiments described herein. Repetitive description of like elements employed in other embodiments described herein is omitted for sake of brevity.

Upon or after a start of the pan/move function test 300 is requested (e.g., through a selection of the test through the touchscreen via the interface component 108, through an audible selection, or through other manners of selecting the pan/move function test 300), a first embodiment 400 of the pan/move function test 300 can be rendered as illustrated in FIG. 4. As indicated, the test object 306 is rendered, however, the ghost object 308 is not rendered. According to some implementations, the ghost object 308, at the beginning of the pan/move function test 300 can be at substantially the same location as the test object 306 and, therefore, cannot be seen. However, upon or after the start of the pan/move function test 300, the ghost object 308 can be rendered to provide an indication of how the test object 306 should be moved on the screen.

Upon or after the test object 306 is moved from the start position 316 to the stop position 318, a second embodiment 500 of the pan/move function test 300 can be automatically rendered as illustrated in FIG. 5. In the second embodiment 500 the test channel 302 can be rotated and flipped such that the start position 316 is located at a different location on the display screen. Upon or after the second embodiment 500 of the pan/move function test 300 is completed (e.g., the test object 306 has been moved from the start position 316 to the stop position 318), a third embodiment 600 of the pan/move function test 300 can be automatically rendered.

As illustrated by the third embodiment 600, the start position 316 is again at a different location on the screen. Further, upon or after completion of the third embodiment 600 (e.g., the test object 306 has been moved from the start position 316 to the stop position 318), a fourth embodiment 700 can be automatically rendered as illustrated in FIG. 7. Upon or after completion of the fourth embodiment 700, the pan/move function test 300 can be completed.

Accordingly, as illustrated by FIGS. 4-7, the pan/move function test 300 can progress through the different directions (e.g., four directions in this example). Further, flipping between the different track embodiments can be utilized to average out various issues that could occur while performing the tracking on the different directions. Further, flipping between the different track embodiments can be utilized to average out various issues that could occur while performing the tracking on the different directions. For example, depending on whether an object (e.g., a finger) is placed on the screen from a left-handed direction or a right-handed direction, at least a portion of the screen could be obscured. For example, for FIGS. 4 and 6, if the object is placed on the screen in a right-handed direction, as the test object 306 is moved from the start position 316, the start position 316 could be obstructed during a portion of the pan/move function test 300. In a similar manner, for FIGS. 5 and 7, if the object is placed on the screen in a left-handed direction, during a portion of the pan/move function test 300, the start position 316 could be obstructed during a portion of the pan/move function test 300.

FIGS. 8-10 illustrate example, non-limiting implementations of an increase/decrease function test in accordance with one or more embodiments described herein. Repetitive description of like elements employed in other embodiments described herein is omitted for sake of brevity.

The increase/decrease function test can be designed to test increase and/or decrease functions with different gestures. Similar to the pan/move function test 300 of FIG. 3, the increase/decrease function test can comprise the test object 306. Further, upon or after movement of the test object 306 (or anticipated movement of the test object 306), the ghost object 308 can be rendered. A purpose of the increase/decrease function test can be to determine which gesture(s) can be the most appropriate gesture to achieve a function or a desired intent.

FIG. 8 illustrates a first embodiment 800 of an increase/decrease function test in accordance with one or more embodiments described herein. The increase/decrease function tests, as well as other tests discussed herein, can be multi-touch tests where more than one portion of the touchscreen can be touched at about the same time. Illustrated are a first slider 802 and a second slider 804. For the first slider 802, the test object 306 can be configured to move upward from the start position 316 to the stop position 318. Further, the second slider 804 can be configured to test movement of the test object 306 from the start position 316 downward to the stop position 318. Accordingly, the first embodiment 800 can test upward and downward movement for accuracy and/or speed.

Upon or after completion of the first embodiment 800 of the increase/decrease function test, a second embodiment 900 of the increase/decrease function test can be rendered. The second embodiment 900 comprises a first slider 902 that can be utilized to test a gesture that moves the test object 306 from the start position 316 (on the left) toward the stop position 318 (on the right). Further, a second slider 904 can be utilized to test a gesture that moves the test object 306 from the start position 316 (on the right) toward the stop position 318 (on the left). Thus, the second embodiment 900 can test a horizontal movement in left and right directions. According to some implementations, the first slider 902 and the second slider 904 can be centered in the horizontal direction on the display screen. However, other locations can be utilized for the first slider 902 and the second slider 904.

A third embodiment 1000 of the increase/decrease function test, as illustrated in FIG. 10, can be rendered upon or after completion of the second embodiment. The third embodiment 1000 can test rotational movement of one or more gestures. Thus, as illustrated by a first rotational track 1002, the test object 306 can be attempted to be moved from the start position 316 in a clockwise direction to the stop position 318. Further, as illustrated by a second rotational track 1004, the test object 306 can be attempted to be moved from the start position 316 in a counterclockwise direction to the stop position 318. As illustrated, respective bottom portions of the first rotational track 1002 and the second rotational track 1004 can be removed such that a complete circle is not tracked during the third embodiment 1000. According to some implementations, the first rotational track 1002 and the second rotational track 1004 can be centered on the display in a vertical direction (e.g., the Y direction).

Further, upon or after completion of the third embodiment 1000, a fourth embodiment 1100 of the increase/decrease function test can be rendered as illustrated in FIG. 11. A first implementation 1102 of the fourth embodiment 1100 is illustrated on the left side of FIG. 11. In the first implementation 1102, the start position 316 is located at about the middle of a circular shape. The first implementation 1102 can be utilized to test a zoom out function that can be performed by moving two objects (e.g., two fingers) away from one other and outward toward the outer portion of the circle, which can be the stop position 318.

A second implementation 1104 of the of the fourth embodiment 1100 is illustrated on the right side of FIG. 11. In the second implementation 1104, the start position 316 is located at the outermost portion of a circular shape. The second implementation 1104 can be utilized to test a pinch function that can be performed by moving two objects (e.g., two fingers) toward one other and inward to the middle of the circle, which can be the stop position 318.

According to some implementations, the increase/decrease function task can be utilized to test increase and decrease function with different gestures. Timing can start when the test object is touched. Further a measurement of performance can be the time it takes to get to 50% (or another percentage), which can be determined when: Force=0 and Value=50 (for two seconds), for example. A readout can appear near the test object to demonstrate the current value/position of the test object.

According to an implementation, if the test object is touched and held, the slider can still be active if the user moves their finger off the touch object while maintaining contact with the screen (this is similar to the user expectation of current touchscreen devices). If the user removers their finger from the test object, the test object can will remain where it was left and not reset.

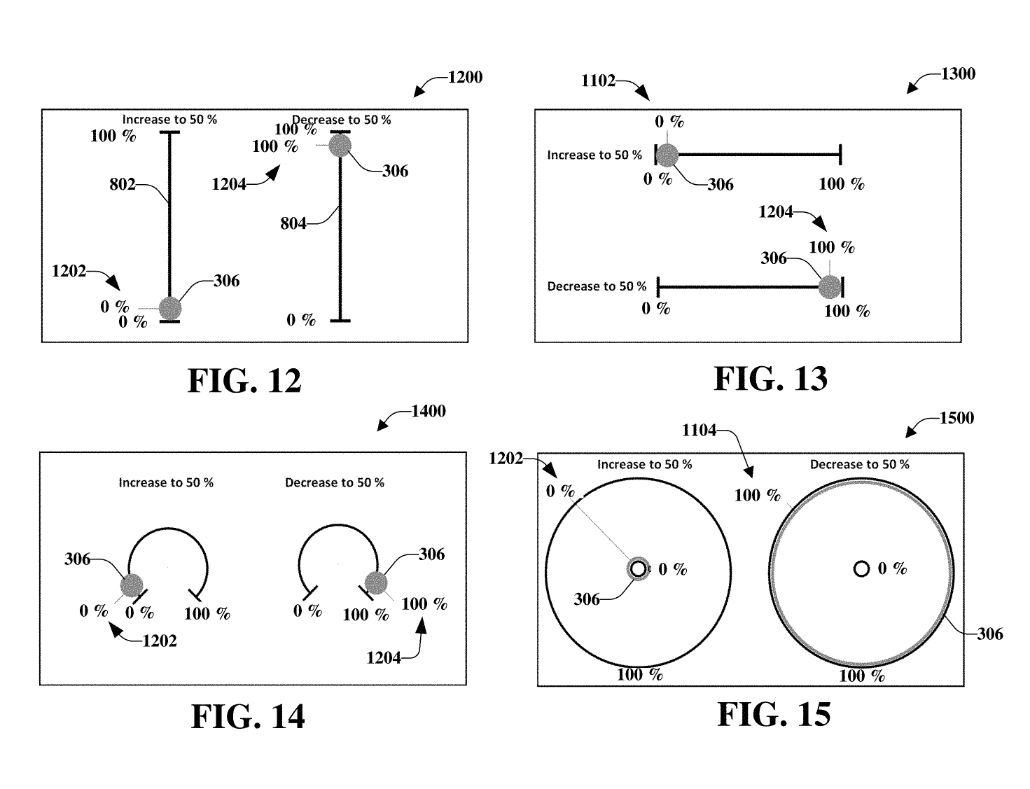

FIGS. 12-15 illustrate example, non-limiting, implementations of another increase/decrease function test in accordance with one or more embodiments described herein. Repetitive description of like elements employed in other embodiments described herein is omitted for sake of brevity.

The increase/decrease function tests of FIGS. 12-15 are similar to the increase/decrease function tests of FIGS. 8-11. However, in this example, the gesture is performed up to a certain percentage of a full movement (as discussed with respect to FIGS. 8-11). Further, the increase/decrease function tests of FIGS. 12-15 can be multi-touch tests.

For example, in a first embodiment 1200 of FIG. 12, a first readout 1202 and a second readout 1204 can be rendered as hovering to respective sides of the test object 306. Although illustrated to the left of the test object 306, the first readout 1202 and the second readout 1204 can be to the right of the test object 306, or located at another position relative to the test object 306. According to some implementations, the first readout 1202 and/or the second readout 1204 can be located inside the test object 306. Thus, the first slider 802 can be utilized to move the test object from 0% to another percentage (e.g., 50%). The second slider 804 can be utilized to move the slider from 100% to a lower percentage (e.g., 50%). A value of the first readout 1202 and another value of the second readout 1204 can change automatically as the test object 306 is moved. The error observed in the first embodiment 1200 can be determined based on how closely the gesture stop at the desired percentage (e.g., 50% in this example).

Upon or after completion of the first embodiment 1200, a second embodiment 1300 can be automatically rendered. The second embodiment 1300 is similar to the second embodiment 900 of FIG. 9. As illustrated, the first readout 1202 and the second readout 1204 can hover above the test object 306. However, the disclosed aspects are not limited to this implementation and the first readout 1202 and the second readout 1204 can be positioned at various other locations.

FIG. 14 illustrates a third embodiment 1400 that can be rendered upon or after completion of the second embodiment 1300. The test object 306 can be moved in a similar manner as discussed with respect to FIG. 10. However, in the third embodiment 1400 the ability to rotate the test object 306 only to a certain percentage can be tested. Upon or after completion of the third embodiment 1400, a fourth embodiment 1500, as illustrated in FIG. 15 can be rendered. The fourth embodiment 1500 is similar to the test conducted with respect to FIG. 11, however, only a certain percentage of movement is tested.

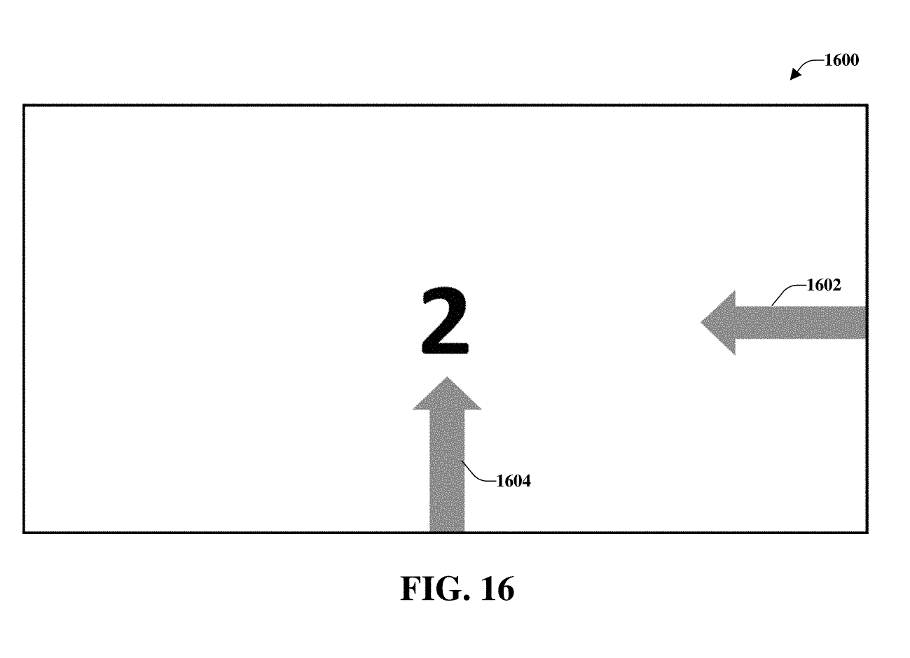

FIG. 16 illustrates a representation of an example, non-limiting, “go to” function task 1600 that can be implemented in accordance with one or more embodiments described herein. Repetitive description of like elements employed in other embodiments described herein is omitted for sake of brevity. The task for this test can be to swipe gestures in multiple different directions (e.g., four or more separate directions).

By way of example and not limitation, a first swipe gesture can be to swipe, “flick,” or rapidly move an object in the direction of a first arrow 1602. For example, the gesture can be in a direction from the side of the screen to a middle of the screen, however, other directions for the swipe gesture can be utilized with the disclosed aspects. According to these other implementations, the one or more arrows (e.g., swipe direction arrows) can indicate the direction of the swipe. As illustrated, in FIG. 16, the first swipe gesture has been completed and instructions for a second swipe gesture can be provided automatically. For example, a second arrow 1604 can be output in conjunction with a numerical indication (or other indication type) of the swipe number (e.g., 2 in this example, which is the second swipe gesture). In some implementations, the swipe direction arrows (e.g., the first arrow 1602, the second arrow 1604, and subsequent arrows) can be centered on the horizontal direction and/or the vertical direction depending on the location within the screen. According to other implementations, the direction arrows can be located at any placement on the screen. Upon or after completion of the second swipe gesture, a third swipe gesture instruction can be output automatically. This process can continue until all the test swipe gestures have been successfully completed, or after a time limit for the test has expired.

According to some implementations, task timing can start when the first touch is detected on the first swipe slide. The task timing can end when the last swipe is completed correctly. Performance can be measured by time to completion. Further, the amount of time between completion of each task and start of the next task can be collected. For example, after completion of the first swipe gesture, it can take time to move to a starting position of the second swipe gesture. Further, after completion of the second swipe gesture, time can be expending moving to the third swipe gesture, and so on until completion of the “go to” function task. In addition, a number of touches that are received, but which are not swipe, can be tracked for analysis and for training the model.

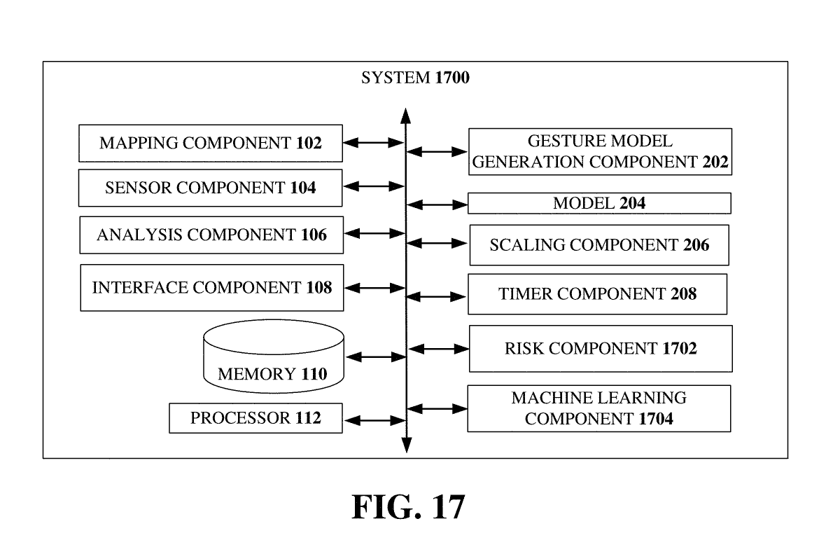

FIG. 17 illustrates another example, non-limiting, system 1700 for function gesture evaluation in accordance with one or more embodiments described herein. Repetitive description of like elements employed in other embodiments described herein is omitted for sake of brevity.

The system 1700 can comprise one or more of the components and/or functionality of the system 100 and/or the system 200, and vice versa. According to some implementations, the analysis component 106 can perform a utility-based analysis as a function of a benefit of accurately determining gesture intent with a cost of an inaccurate determination of gesture intent. Further, a risk component 1702 can regulate acceptable error rates as a function of acceptable risk associated with a defined task. Thus, the benefit of an accurate gesture intent versus a cost of an inaccurate gesture intent can be weighted and taken into consideration for the gesture model 204. For example, if there is an inaccurate prediction made with respect to changing a radio station, there can be negligible cost associated with that inaccurate prediction. However, if the prediction (and associated task) is associated with navigation of an aircraft or automobile, a confidence level associated with the accuracy of the prediction should be very high (e.g., 99% confidence), otherwise an accident could occur due to the inaccurate prediction.

The system 1700 can also include a machine learning and reasoning component 1704, which can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning and reasoning component 1704 can employ principles of probabilistic and decision theoretic inference. Additionally, or alternatively, the machine learning and reasoning component 1704 can rely on predictive models constructed using machine learning and/or automated learning procedures. Logic-centric inference can also be employed separately or in conjunction with probabilistic methods.

The machine learning and reasoning component 1704 can infer a gesture intent based on one or more received gestures. According to a specific implementation, the system 1700 can be implemented for onboard avionics of an aircraft. Accordingly, the gesture intent could relate to various aspects related to navigation of the aircraft. Based on the knowledge, the machine learning and reasoning component 1704 can train a model (e.g., the gesture model 204) to make an inference based on whether one or more gestures were actually received and/or one or more actions to take based on the one or more gestures.

As used herein, the term “inference” refers generally to the process of reasoning about or inferring states of the system, a component, a module, the environment, and/or assets from a set of observations as captured through events, reports, data and/or through other forms of communication. Inference can be employed to identify a specific context or action, or can generate a probability distribution over states, for example. The inference can be probabilistic. For example, computation of a probability distribution over states of interest based on a consideration of data and/or events. The inference can also refer to techniques employed for composing higher-level events from a set of events and/or data. Such inference can result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

The various aspects (e.g., in connection with standardized tests for touchscreen gesture evaluation, standardized tests for touchscreen gesture evaluation in an unstable environment, and so on) can employ various artificial intelligence-based schemes for carrying out various aspects thereof. For example, a process for evaluating one or more gestures received at a display unit can be utilized to predict an action that should be carried out and/or a risk associated with implementation of the action, which can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to prognose or infer an action that should be implemented based on a received gesture, whether the gesture was properly performed, whether to selectively disregard a gesture, and so on. In the case of touchscreen gestures, for example, attributes can be identification of a known gesture pattern based on historical information (e.g., the gesture model 204) and the classes can be criteria of how to interpret and implement one or more actions based on the gesture.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording gesture behavior, evaluating gesture behavior in both a stable environment and an unstable environment, by receiving extrinsic information (e.g., cloud-based sharing, and so on). For example, SVM's can be configured through a learning or training phase within a classifier constructor and feature selection module. Thus, a classifier(s) can be used to automatically learn and perform a number of functions, including but not limited to determining according to a predetermined criteria how to interpret a gesture, whether a gesture can be performed in a stable environment or an unstable environment, changes to a gesture that cannot be successfully performed in the environment, and so forth. The criteria can include, but is not limited to, similar gestures, historical information, aggregated information, and so forth.

Additionally, or alternatively, an implementation scheme (e.g., a rule, a policy, and so on) can be applied to control and/or regulate performance and/or interpretation of one or more gestures. In some implementations, based upon a predefined criterion, the rules-based implementation can automatically and/or dynamically interpret how to respond to a particular gesture. In response thereto, the rule-based implementation can automatically interpret and carry out functions associated with the gesture based on a cost-benefit analysis and/or a risk analysis by employing a predefined and/or programmed rule(s) based upon any desired criteria.

Computer-implemented methods that can be implemented in accordance with the disclosed subject matter, will be better appreciated with reference to the following flow charts. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks are required to implement the disclosed methods. It is to be appreciated that the functionality associated with the blocks can be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram. According to some implementations, the methods can be performed by a system comprising a processor. Additionally, or alternatively, the methods can be performed by a machine-readable storage medium and/or a non-transitory computer-readable medium, comprising executable instructions that, when executed by a processor, facilitate performance of the methods.

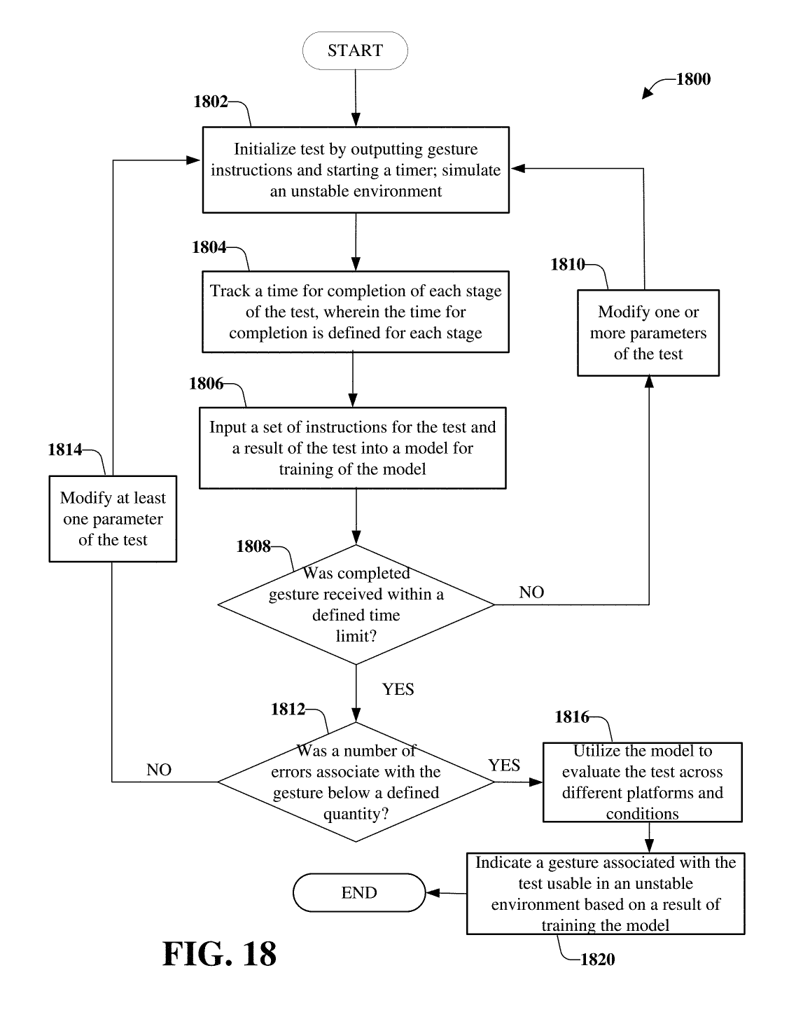

FIG. 18 illustrates an example, non-limiting, computer-implemented method 1800 for facilitating touchscreen evaluation tasks intended to evaluate gesture usability for touchscreen functions in accordance with one or more embodiments described herein. Repetitive description of like elements employed in other embodiments described herein is omitted for sake of brevity.

The computer-implemented method 1800 starts, at 1802, when a test is initialized. For example, the test can be initialized based on a received input that indicates the test is to be conducted. To initialize the test, gesture instructions can be output or rendered on a display screen. According to some implementations, a timer can be started at substantially the same time as the instructions are provided or after a first gesture is detected. Further, during the test, a defined environment (e.g., a stable environment, an unstable environment, a moving environment, a bumpy environment, and so on) can be simulated. At 1804 of the computer-implemented method 1800, a time for completion of each stage of the test can be tracked. According to some implementations, an overall time for completion of the test can be specified.

Upon or after successful completion of the test, or after a timer has expired, information related to the test can be input into a model at 1806 of the computer-implemented method 1800. For example, the set of instructions for the test, a result of the test, and other information associated with the test (e.g., simulated environment information) can be input into the model. The model can aggregate the test data with other, historical test data. In an example, the data can be aggregated with other data received via a cloud-based sharing platform.

At 1808 of the computer-implemented method 1800, a determination can be made whether the test was completed in a defined amount of time. For example, the determination can be made on a gesture by gesture basis (e.g., at individual stages of the test) or for the overall time for completion of the test. If the gesture was not successfully completed in the defined amount of time (“NO”), at 1810 of the computer-implemented method 1800 one or more parameters of the test can be modified and a next test can be initiated at 1802.

If the completed gesture was received in the defined amount of time (“YES”), at 1812 of the computer-implemented method 1800, a determination is made whether a number of errors associated with the gesture were below a defined number of errors. For example, if the environment is unstable, one or more errors (e.g., a finger lifting off the display screen, unintended movement) can be expected. If the number of errors was not below the defined quantity (“NO”), at 1812 of the computer-implemented method 1800 at least one parameter of the test can be modified and the modified test can be initialized at 1802. According to some implementations, the one or more parameters modified at 1808 and the at least one parameter modified at 1812 can be the same parameter or can be different parameters.

If the determination at 1812 is that the number of errors is below the defined quantity (“YES), at 1816 the model can be utilized to evaluate the test across different platforms and conditions. For example, the test can be performed utilizing different input devices (e.g., mobile devices) that can comprise different display screen sizes, different operating systems, and so on. Accordingly, a multitude of tests can be conducted to determine if the gesture is suitable across a multitude of devices.

If the gesture is suitable across the multitude of devices, at 1818, the gesture associated with the test can be indicated as usable in the tested environment. Over time, the gesture can be retested for other input devices and/or other operating conditions.

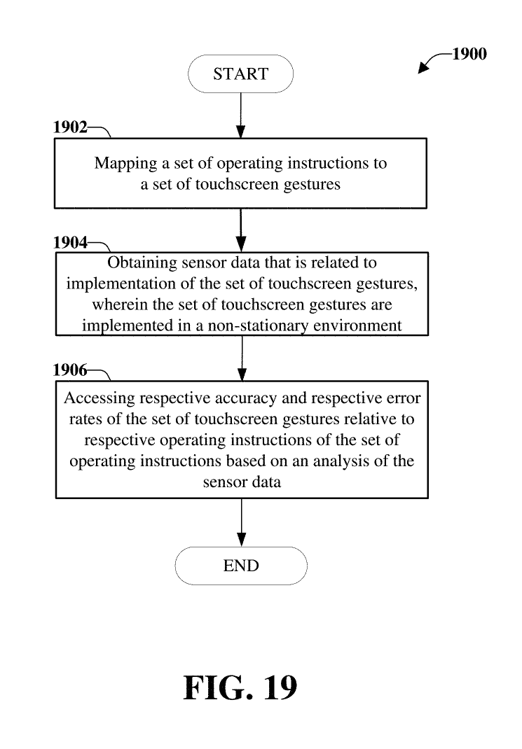

FIG. 19 illustrates an example, non-limiting, computer-implemented method 1900 for generating standardized tests for touchscreen gesture evaluation in accordance with one or more embodiments described herein. Repetitive description of like elements employed in other embodiments described herein is omitted for sake of brevity.

At 1902 of the computer-implemented method 1900, a set of operating instructions can be mapped to a set of touchscreen gestures (e.g., via the mapping component 102). The operating instructions can comprise a defined set of related tasks performed with respect to a touchscreen of a computing device. For example, a set of operating instructions can be defined and expected gestures associated with the operating instructions can be defined. According to some implementations mapping the gestures to the operating instructions can comprise learning touchscreen gestures relative to the respective operating instructions of the set of operating instructions. For example, the learning can be based on a gesture model trained on the set of gestures.

Sensor data related to implementation of the set of touchscreen gestures can be collected at 1904 of the computer-implemented method 1900 (e.g., via the sensor component 104). According to some implementations, the set of touchscreen gestures can be implemented in a non-stationary environment. The non-stationary environment can be an environment that is subject to vertical movement that can produce unexpected vibration and/or turbulence. According to various implementations, the non-stationary environment can be a simulated environment (e.g., a controlled non-stationary environment) configured to mimic conditions of a target test environment.

At 1906 of the computer-implemented method 1900, performance score/data and/or usability score/data of the set of touchscreen gestures can be assessed relative to respective operating instructions of the set of operating instructions based on an analysis of the sensor data. One or more errors can be measured as a function of respective time spent deviating from a target path defined for at least one gesture of the set of touchscreen gestures.

According to some implementations, assessing the performance score/data and/or usability score/data can include performing the touchscreen gesture analysis as a function of respective sizes of one or more objects (e.g., fingers) detected by the touchscreen of the computing device. For example, the object can be one or more fingers or another item that can be utilized to interact with a touchscreen display. In some implementations, assessing the performance and/or usability score/data can include performing touchscreen gesture analysis as a function of touchscreen dimensions of the computing device.

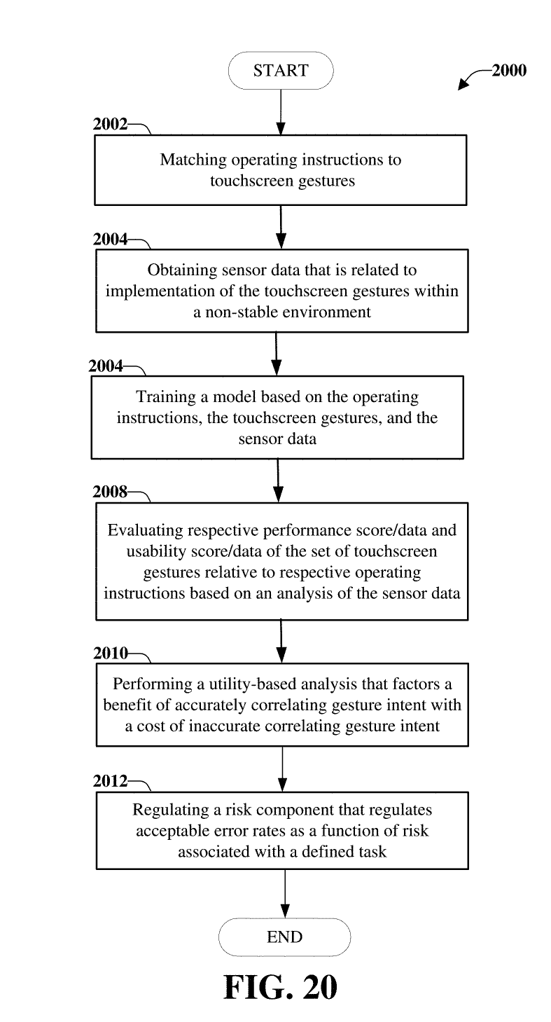

FIG. 20 illustrates an example, non-limiting, computer-implemented method 2000 for evaluating risk benefit analysis associated with touchscreen gesture evaluation in accordance with one or more embodiments described herein. Repetitive description of like elements employed in other embodiments described herein is omitted for sake of brevity.

The computer-implemented method 2000 starts at 2002 when operating instructions can be matched to touchscreen gestures (e.g., via the mapping component 102). Sensor data associated with the set of touchscreen gestures can be collected, at 2004 of the computer-implemented method (e.g., via the sensor component 104). For example, the sensor data can be collected from one or more sensors associated with a touchscreen device. A model can be trained, at 2006 of the computer-implemented method 2006 (e.g., via the gesture model generation component 202). For example, the model can be trained based on the operating instructions, the set of touchscreen gestures, and the sensor data.

At 2008 of the computer-implemented method 2000, respective performance score/data and usability score/data of the touchscreen gestures can be evaluated relative to respective operating instructions based on an analysis of the sensor data (e.g., via the analysis component 106).

At 2010 of the computer-implemented method, a utility-based analysis can be performed. The utility-based analysis can be performed as a function of a benefit of accurately determining gesture intent with a cost of an inaccurate determination of gesture intent (e.g., via the analysis component 106).

Further, at 2012 of the computer-implemented method, acceptable error rates can be regulated as a function of risk associated with a defined task (e.g., via the risk component 1702). For example, a cost associated with inaccurately predicting a first intent associated with a first gesture can be low (e.g., a low amount of risk is involved) while a second cost associated with inaccurately predicting a second intent associated with a second gesture can be high (e.g., a large amount of risk is involved).

According to some implementations, the computer-implemented method 2000 can comprise generating a gesture model based on operating data received from a plurality of entities. Further to these implementations, the computer-implemented method 2000 can comprise training the gesture model through cloud-based sharing across a plurality of models. The plurality of models can be based on the operating data received from the plurality of computing devices.

As discussed herein, provided is a series of computer based evaluation tasks designed to evaluate gesture usability for touchscreen functions. The various aspects can evaluate the usability of gestures for a given function. For example, the usability can be determined by the time expended for the tasks to be completed, the accuracy in which the tasks were completed, or a combination of both accuracy and time to completion.

As discussed herein, a system can comprise a memory that stores executable components and a processor, operatively coupled to the memory, that executes the executable components. The executable components can comprise a mapping component that correlates a set of operating instructions to a set of touchscreen gestures. The operating instructions can comprise at least one defined task performed with respect to a touchscreen of a computing device. The executable components can also comprise a sensor component that receives sensor data from a plurality of sensors. The sensor data can be related to implementation of the set of touchscreen gestures. The set of touchscreen gestures can be implemented in an environment that experiences vibration or turbulence, or in a more stable environment. Further, the executable components can comprise an analysis component that analyzes the sensor data and assesses respective performance score/data and usability score/data of the set of touchscreen gestures relative to respective operating instructions of the set of operating instructions. The respective performance score/data and usability score/data can be a function of a suitability of the touchscreen gestures within the testing environment.

In an implementation, the executable components can comprise a gesture model that learns touchscreen gestures relative to the respective operating instructions of the set of operating instructions. The operating instructions can comprise a defined set of related tasks performed with respect to a touchscreen of a computing device. In some implementations, one or more errors can be measured as a function of respective time spent deviating from a target path associated with the at least one defined path. According to another implementation, the executable components can comprise a scaling component that performs touchscreen gesture analysis as a function of touchscreen dimensions of the computing device. Further to this implementation, the scaling component can perform the touchscreen gesture analysis as a function of respective sizes of one or more objects detected by the touchscreen of the computing device.

In some implementations, the executable components can comprise a gesture model generation component that can generate a gesture model based on operating data received from a plurality of entities. Further to this implementation, the gesture model can be trained through cloud-based sharing across a plurality of models. According to some implementations, the analysis component can perform a utility-based analysis as a function of a benefit of accurately determining gesture intent with a cost of an inaccurate determination of gesture intent. Further to these implementations, the executable components can comprise a risk component that can regulate acceptable error rates as a function of acceptable risk associated with a defined task.

A computer-implemented method can comprise mapping, by a system comprising a processor, a set of operating instructions to a set of touchscreen gestures. The computer-implemented method can also comprise obtaining, by the system, sensor data that is related to implementation of the set of touchscreen gestures. The set of touchscreen gestures can be implemented in a controlled non-stationary environment. Further, the computer-implemented method can comprise assessing, by the system, respective performance score/data and usability score/data of the set of touchscreen gestures relative to respective operating instructions of the set of operating instructions based on an analysis of the sensor data.

In an implementation, the computer-implemented method can comprise learning, by the system, touchscreen gestures relative to the respective operating instructions of the set of operating instructions. In accordance with some implementations, the computer-implemented method can comprise measuring, by the system, one or more errors as a function of respective time spent deviating from a target path defined for at least one gesture of the set of touchscreen gestures. According to some implementations, the computer-implemented method can comprise performing, by the system, touchscreen gesture analysis as a function of touchscreen dimensions of the computing device. Further to these implementations, the computer-implemented method can comprise performing, by the system, the touchscreen gesture analysis as a function of respective sizes of one or more objects detected by the touchscreen of the computing device.

The computer-implemented method can also comprise, according to some implementations, generating, by the system, a gesture model based on operating data received from a plurality of computing devices. Further to these implementations, the computer-implemented method can comprise training, by the system, the gesture model through cloud-based sharing across a plurality of models. The plurality of models can be based on the operating data received from the plurality of computing devices.

In an alternative or additional implementation, the computer-implemented method can comprise performing, by the system, a utility-based analysis that factors a benefit of accurately correlating gesture intent with a cost of inaccurate correlating of gesture intent. Further to this implementation, the computer-implemented method can comprise regulating, by the system, acceptable error rates as a function of acceptable risk associated with a defined task.

Further, provided herein is a computer readable storage device comprising executable instructions that, in response to execution, cause a system comprising a processor to perform operations. The operations can comprise matching a set of operating instructions to a set of touchscreen gestures and obtaining sensor data that is related to implementation of the set of touchscreen gestures within a non-stable environment. The operations can also comprise training a model based on the set of operating instructions, the set of touchscreen gestures, and the sensor data. Further, the operations can also comprise analyzing respective performance score/data and or usability score/data of the set of touchscreen gestures relative to respective operating instructions of the set of operating instructions based on an analysis of the sensor data.

According to some implementations, the operations can comprise performing a utility-based analysis as a function of a benefit of accurately determining gesture intent with a cost of an inaccurate determination of gesture intent. Further to these implementations, the operations can comprise regulating a risk component that regulates acceptable error rates as a function of acceptable risk associated with a defined task.

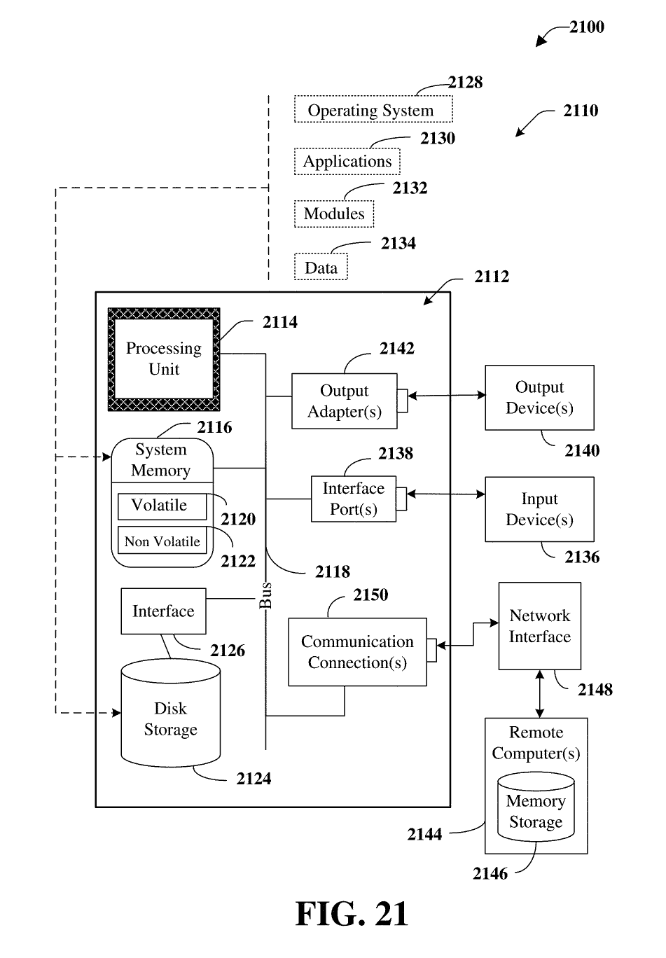

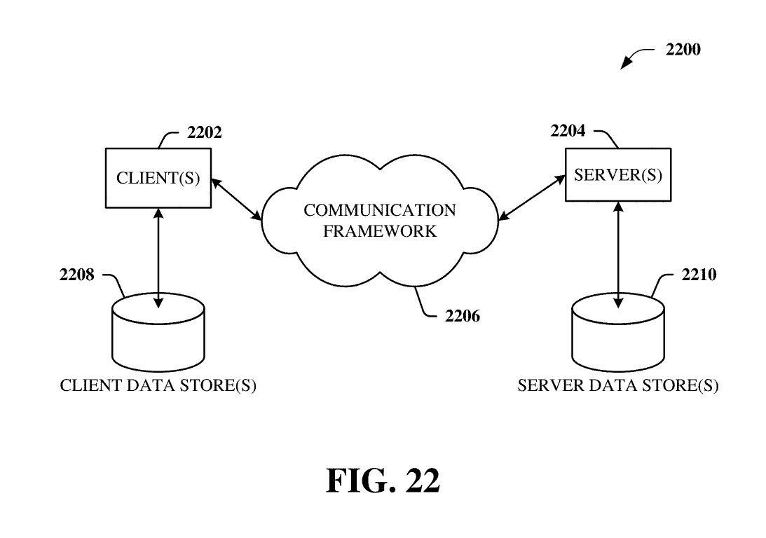

In order to provide context for the various aspects of the disclosed subject matter, FIGS. 21 and 22 as well as the following discussion are intended to provide a brief, general description of a suitable environment in which the various aspects of the disclosed subject matter can be implemented.

With reference to FIG. 21, an example environment 2110 for implementing various aspects of the aforementioned subject matter includes a computer 2112. The computer 2112 includes a processing unit 2114, a system memory 2116, and a system bus 2118. The system bus 2118 couples system components as illustrated in FIG. 21. The processing unit 2114 can be any of various available processors. Multi-core microprocessors and other multiprocessor architectures also can be employed as the processing unit 2114.

The system bus 2118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 2116 includes volatile memory 2120 and nonvolatile memory 2122. The basic input/output system (BIOS), containing the basic routines to transfer information between elements within the computer 2112, such as during start-up, is stored in nonvolatile memory 2122. By way of illustration, and not limitation, nonvolatile memory 2122 can include read only memory (ROM), programmable ROM (PROM), electrically programmable ROM (EPROM), electrically erasable PROM (EEPROM), or flash memory. Volatile memory 2120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2112 also includes removable/non-removable, volatile/non-volatile computer storage media. FIG. 21 illustrates, for example a disk storage 2124. Disk storage 2124 includes, but is not limited to, devices like a magnetic disk drive, floppy disk drive, tape drive, Jaz drive, Zip drive, LS-100 drive, flash memory card, or memory stick. In addition, disk storage 2124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 2124 to the system bus 2118, a removable or non-removable interface is typically used such as interface 2126.

It is to be appreciated that FIG. 21 describes software that acts as an intermediary between users and the basic computer resources described in suitable operating environment 2110. Such software includes an operating system 2128. Operating system 2128, which can be stored on disk storage 2124, acts to control and allocate resources of the computer 2112. System applications 2130 take advantage of the management of resources by operating system 2128 through program modules 2132 and program data 2134 stored either in system memory 2116 or on disk storage 2124. It is to be appreciated that one or more embodiments of the subject disclosure can be implemented with various operating systems or combinations of operating systems.

A user enters commands or information into the computer 2112 through input device(s) 2136. Input devices 2136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2114 through the system bus 2118 via interface port(s) 2138. Interface port(s) 2138 include, for example, a serial port, a parallel port, a game port, and a universal serial bus (USB). Output device(s) 2140 use some of the same type of ports as input device(s) 2136. Thus, for example, a USB port can be used to provide input to computer 2112, and to output information from computer 2112 to an output device 2140. Output adapters 2142 are provided to illustrate that there are some output devices 2140 like monitors, speakers, and printers, among other output devices 2140, which require special adapters. The output adapters 2142 include, by way of illustration and not limitation, video and sound cards that provide a means of connection between the output device 2140 and the system bus 2118. It should be noted that other devices and/or systems of devices provide both input and output capabilities such as remote computer(s) 2144.

Computer 2112 can operate in a networked environment using logical connections to one or more remote computers, such as remote computer(s) 2144. The remote computer(s) 2144 can be a personal computer, a server, a router, a network PC, a workstation, a microprocessor based appliance, a peer device or other common network node and the like, and typically includes many or all of the elements described relative to computer 2112. For purposes of brevity, only a memory storage device 2146 is illustrated with remote computer(s) 2144. Remote computer(s) 2144 is logically connected to computer 2112 through a network interface 2148 and then physically connected via communication connection 2150. Network interface 2148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2150 refers to the hardware/software employed to connect the network interface 2148 to the system bus 2118. While communication connection 2150 is shown for illustrative clarity inside computer 2112, it can also be external to computer 2112. The hardware/software necessary for connection to the network interface 2148 includes, for exemplary purposes only, internal and external technologies such as, modems including regular telephone grade modems, cable modems and DSL modems, ISDN adapters, and Ethernet cards.

FIG. 22 is a schematic block diagram of a sample computing environment 2200 with which the disclosed subject matter can interact. The sample computing environment 2200 includes one or more client(s) 2202. The client(s) 2202 can be hardware and/or software (e.g., threads, processes, computing devices). The sample computing environment 2200 also includes one or more server(s) 2204. The server(s) 2204 can also be hardware and/or software (e.g., threads, processes, computing devices). The servers 2204 can house threads to perform transformations by employing one or more embodiments as described herein, for example. One possible communication between a client 2202 and servers 2204 can be in the form of a data packet adapted to be transmitted between two or more computer processes. The sample computing environment 2200 includes a communication framework 2206 that can be employed to facilitate communications between the client(s) 2202 and the server(s) 2204. The client(s) 2202 are operably connected to one or more client data store(s) 2208 that can be employed to store information local to the client(s) 2202. Similarly, the server(s) 2204 are operably connected to one or more server data store(s) 2210 that can be employed to store information local to the servers 2204.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can comprise, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory (110) that stores executable components; and
a processor (112), operatively coupled to the memory, that executes the executable components, the executable components comprising:
a mapping component (102) that correlates a set of operating instructions to a set of touchscreen gestures, wherein the operating instructions comprise at least one defined task performed with respect to a touchscreen of a computing device;
a sensor component (104) that receives sensor data from a plurality of sensors, wherein the sensor data is related to implementation of the set of touchscreen gestures; and
an analysis component (106) that analyzes the sensor data and assesses respective performance data and usability data of the set of touchscreen gestures relative to respective operating instructions of the set of operating instructions, wherein the respective performance data and usability data are a function of suitability of the set of touchscreen gestures.

2. The system of claim 1, further comprising a gesture model that learns touchscreen gestures relative to the respective operating instructions of the set of operating instructions.

3. The system of claim 1, wherein one or more errors are measured as a function of respective time spent deviating from a target path associated with the at least one defined path.

4. The system of claim 1, further comprising a scaling component that performs touchscreen gesture analysis as a function of touchscreen dimensions of the computing device.

5. The system of claim 4, wherein the scaling component performs the touchscreen gesture analysis as a function of respective sizes of one or more objects detected by the touchscreen of the computing device.

6. The system of claim 1, further comprising a gesture model generation component that generates a gesture model based on operating data received from a plurality of computing devices, wherein the gesture model is trained through cloud-based sharing across a plurality of models, wherein the plurality of models are based on the operating data received from the plurality of computing devices.

7. The system of claim 1, wherein the analysis component performs a utility-based analysis as a function of a benefit of accurately determining gesture intent with a cost of an inaccurate determination of gesture intent.

8. The system of claim 7, further comprising a risk component that regulates acceptable error rates as a function of acceptable risk associated with a defined task, wherein the set of touchscreen gestures are implemented in an environment that experiences vibration or turbulence.

9. A computer-implemented method, comprising:
mapping, by a system comprising a processor, a set of operating instructions to a set of touchscreen gestures, wherein the operating instructions comprise a defined set of related tasks performed with respect to a touchscreen of a computing device;
obtaining, by the system, sensor data that is related to implementation of the set of touchscreen gestures; and
assessing, by the system, respective performance scores and usability scores of the set of touchscreen gestures relative to respective operating instructions of the set of operating instructions based on an analysis of the sensor data.

10. The computer-implemented method of claim 9, further comprising:
learning, by the system, touchscreen gestures relative to the respective operating instructions of the set of operating instructions.

11. The computer-implemented method of claim 9, further comprising:
measuring, by the system, one or more errors as a function of respective time spent deviating from a target path defined for at least one gesture of the set of touchscreen gestures, wherein the set of touchscreen gestures are implemented in a controlled non-stationary environment.

12. The computer-implemented method of claim 9, further comprising:
performing, by the system, touchscreen gesture analysis as a function of touchscreen dimensions of the computing device.

13. The computer-implemented method of claim 12, further comprising:
performing, by the system, the touchscreen gesture analysis as a function of respective sizes of one or more objects detected by the touchscreen of the computing device.

14. The computer-implemented method of claim 9, further comprising:
generating, by the system, a gesture model based on operating data received from a plurality of computing devices; and
training, by the system, the gesture model through cloud-based sharing across a plurality of models, wherein the plurality of models are based on the operating data received from the plurality of computing devices.

15. The computer-implemented method of claim 9, further comprising:
performing, by the system, a utility-based analysis that factors a benefit of accurately correlating gesture intent with a cost of inaccurate correlating of gesture intent; and
regulating, by the system, a risk component that regulates acceptable error rates as a function of risk associated with a defined task.
